(19) United States
(12) Patent Application Publication
(10) Pub. No.: US 2010/0002746 A1
(43) Pub. Date: Jan. 7, 2010

(54) THERMOMETER

(76) Inventor: Leif Stern, Lomma (SE)

Correspondence Address: Capitol City TechLaw, PLLC, PO BOX 1210, VIENNA, VA, 22183, US

(21) Appl. No.: 12/447,469

(22) PCT Filed: Oct. 25, 2007
(86) PCT No.: PCT/SE07/00934

§ 371 Date: Apr. 27, 2009

(30) Foreign Application Priority Data
Oct. 27, 2006 (SE) 0602261-0

(51) Int. Cl. G01K 1/08; G01K 1/00

(52) U.S. Cl. 374/155; 374/208; 374/E01.001; 374/E01.011

(57) ABSTRACT

The present invention relates to a thermometer for measuring the temperature in foods, preferably meat dishes which thermometer (1) comprises a main element (3), a outer element (4) disposed on the latter, and a sensor (5) which extends through the outer element (4) and is intended to be inserted into food (2) in order to measure the temperature thereof, the outer element (4) being movable relative to the main element (3) and the sensor (5) With the object primarily of protecting the whole sensor (5) outside the main element (3) when the sensor is not in use, the outer element (4) is configured and arranged to conceal the sensor (5) entirely and engages the sensor movably in the main element (3) in order, in the course of movement, to expose variously long portions (5a) of the sensor (5) relative to the outer element (4) so that the exposed portions (5a) can be inserted into the food (2).

### BACKGROUND TO THE INVENTION

The present invention relates to a thermometer for measuring the temperature in foods, preferably meat dishes, which thermometer has a main element, an outer element disposed on the latter, and a sensor which extends through the outer element and is intended to be inserted in the food in order to measure its temperature, the outer element being movable relative to the main element and the sensor.

A thermometer of the configuration indicated is substantially known previously from U.S. Pat. No. 3,373,611 A1.

U.S. Pat. No. 2,916,915 A1 likewise describes a thermometer for measuring the temperature in foods, which thermometer comprises a main element, an outer element and a sensor, the outer element being movable relative to the sensor and the main element. However, the outer element is movable relative to the sensor by being screwed into and out of the main element, which is particularly impractical and time-consuming for simple and rapid temperature measurement.

### BRIEF DESCRIPTION OF THE INVENTION

The object of the present invention is, inter alia, to provide a quickly settable thermometer.

This is achieved by the outer element of the thermometer according to the invention being configured and arranged to conceal the sensor entirely and to engage movably in the main element in order, in the course of movement, to expose variously long portions of the sensor relative to the outer element so that the exposed portions can be inserted into the food.

This arrangement also protects the whole sensor outside the main element when the sensor is not in use.

Other objects and advantages of the invention will be clear to one skilled in the art who examines the attached drawings and the following detailed description of preferred embodiments.

### BRIEF DESCRIPTION OF THE DRAWINGS

FIG. 1 depicts a section of a thermometer according to the invention.

FIG. 2 depicts the same section of the thermometer as in FIG. 1, with a sensor partly exposed.

FIG. 3 depicts an enlarged section of part of the sensor.

FIG. 4 depicts the thermometer according to FIG. 1 placed in a food with the sensor inserted in the food.

### DETAILED DESCRIPTION OF PREFERRED EMBODIMENTS OF THE INVENTION

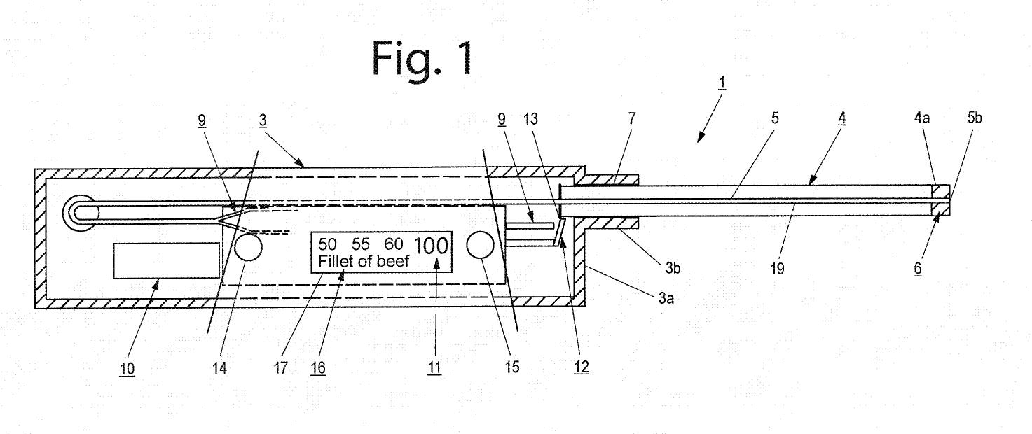

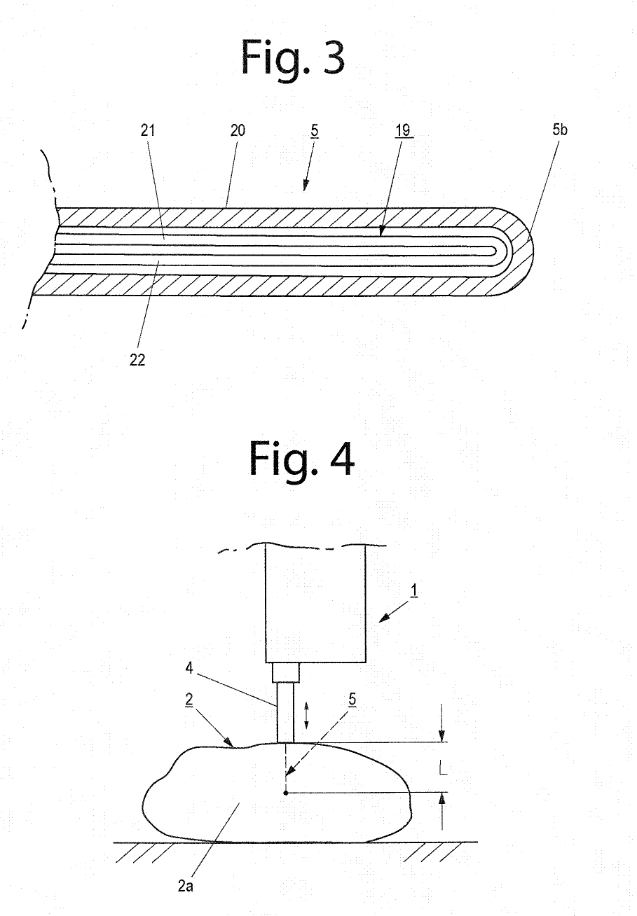

The thermometer 1 depicted in FIGS. 1-4 is intended to measure the temperature in foods 2, preferably meat dishes. The thermometer 1 comprises a main element 3 so configured that it may be held in the hand while a sensor 5 is inserted in a food 2, the temperature in the latter is measured and the sensor 5 is withdrawn. An outer element 4 through which the sensor 5 extends from internal portions of the main element 3 is disposed on the main element 3. The outer element 4 is intended to serve as a stop means when the sensor 5 is inserted in the food 2 and also as a protective sheath for the sensor 5. This outer element 4 is movable relative to the sensor 5 in order to expose variously long portions 5a of the sensor so that these exposed portions 5a can be inserted into the food 2 in order to measure the temperature on suitable portions thereof.

If for example it is desired to measure the temperature on central portions 2a of a food 2, the first step is to estimate the thickness of the food 2 and expose a length L of the sensor 5 which corresponds to half the thickness of the food 2. This may be done by holding the main element 3 in one hand and using the other hand to move the outer element 4 relative to the sensor 5. Thereafter the sensor 5 is inserted into the food 2 until an end portion 4a of the outer element 4 abuts against the food 2 and prevents further insertion of the sensor 5 into the food 2. Assurance is thus provided that the tip 5b of the sensor 5 will be in the central portions 2a of the food 2 whose temperature it is desired to measure and that the sensor 5 can easily be kept in that position.

If the food 2 is thin it may for example only be possible for a portion 5a with a small length L of the sensor 5 to be exposed, and if the food 2 is thick a portion 5a with a greater length L may be exposed. The lengths L of the exposed portions 5a of the sensor 5 may thus be varied so as to make it easy to measure correct temperatures on both thin and thick foods 2.

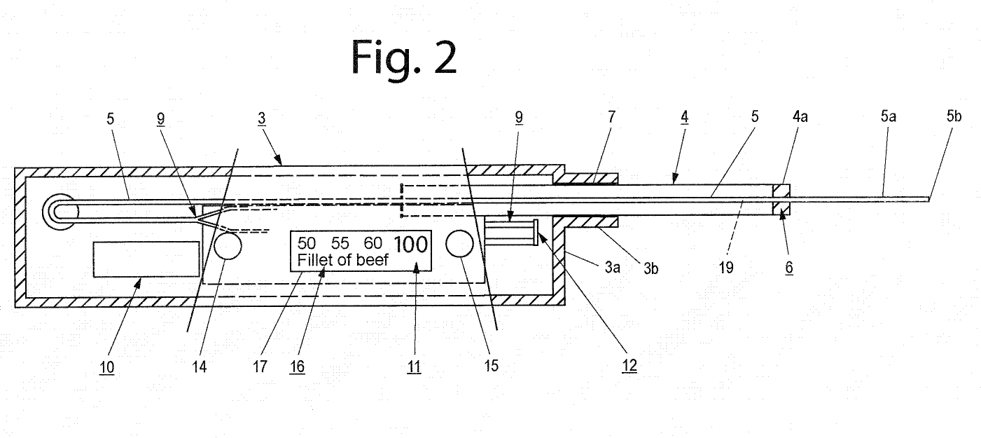

The outer element 4 may be configured and arranged for being pulled out of the main element 3 until it conceals the sensor 5 completely (see FIG. 1). The outer element 4 can thus protect the sensor 5 when the thermometer 1 is not being used. The outer element 4 may also be adapted to being inserted into the main element 3 until it reaches an internal position where portions of the sensor 5 are exposed (see FIG. 2). The outer element 4 is also with advantage so arranged that it becomes stationary in a set position when it abuts against the food 2. This may for example be achieved by arranging in the outer element 4 and/or in the main element 3 a retaining device 6, e.g. a friction bushing, which holds the outer element 4 firmly relative to the sensor 5 by frictional and/or other cooperation with the sensor.

The main element 3 may be substantially cylindrical in shape and the outer element 4 may be oriented axially and disposed off-centre relative to the main element 3. The main element 3 may have at one end 3a a sleeve 3b through which the outer element 4 protrudes from the main element 3. There may be in this sleeve 3b at least one seal means 7, e.g. a sealing ring, which seals between the sleeve 3b and the outer element 4.

The sensor 5 is partly disposed in the main element 3 and extends in the longitudinal direction through the outer element 4, which may for example take the form of a tubular element. The retaining device 6 may abut closely against the sensor 5.

The main element 3 may have an electric circuit 9 which may comprise a battery 10, at least one information device 11 powered electrically by the battery 10, and a circuit-breaker 12. A portion of the outer element 4 situated within the main element 3 may have a contact element 13 which can cooperate with the circuit-breaker 12 in such a way that when the outer element 4 is inserted to an internal position in order to expose a larger portion of the sensor 5 the circuit-breaker 12 closes the circuit 9, and when the outer element 4 is pulled out from the internal position in order to conceal larger portions of the sensor 5 the circuit-breaker 12 breaks the circuit 9. Accordingly, the power supply to the information device 11—and possibly further electrically powered devices not depicted—may be switched on automatically when the sensor 5 is exposed, and vice versa.

The information device 11 may be a device for displaying the instantaneous temperature measured in the food 2 by the thermometer 1 and/or display information 16 about various foods with relating temperature information, i.e. that food X should have the temperature T, food Y the temperature T1 and so on. This food and temperature information 16 may for example be selected manually either by pressing a control button 14, whereupon the information 16 will shift in one direction, or by pressing a control button 15, whereupon the information 16 will shift in the opposite direction, in a window 17 in the main element 3, so that food information with relating temperature information becomes visible each time in the window 17. Instantaneous measured temperatures may be displayed in the same window 17.

The sensor 5 may be configured as or comprise a tubular outer element 20 and an inner element 19 with two metal wires 21, 22. The metal wires 21, 22 may have contact with the tubular outer element 20 at the closed tip 5b of the sensor 5.

The invention is not limited to the aforesaid embodiment but may vary within the scope of the claims set out below. By way of example of undepicted embodiments, it may be mentioned that the main element 3, the outer element 4 and the sensor 5 may take different forms from those depicted and described. The thermometer may of course be used for other foods than meat dishes and it is also possible, where necessary, to use it for measuring temperatures on saucepans etc.

1. A thermometer for measuring the temperature of food, the thermometer comprising:
a main element;
an outer element disposed on the main element; and
a sensor which extends through the outer element;
wherein the outer element movable relative to the sensor; and
wherein the outer element is configured and arranged to be movable between an outer position, in which the outer element, conceals the sensor; and inner positions, in which portions of the sensor are exposed so that the exposed portions can be inserted into the food.

2. A thermometer according to claim 1, wherein the outer element has an end portion adapted to abutting against the food when the exposed portion of the sensor is inserted into the food.

3. A thermometer according to claim 1, wherein the thermometer is provided with a retaining device for holding the outer element in a set position relative to the sensor.

4. A thermometer according to claim 1, wherein the sensor is fixed to the main element.

5. (canceled)

6. A thermometer according to claim 1, wherein the outer element is movable with one hand while using the other hand to hold the main element.

7. A thermometer according to claim 1, wherein the sensor extends in a longitudinal direction through the outer element.

8. A thermometer according to claim 1, wherein the main element has an electric circuit for powering at least one electrically powered device which forms part of the thermometer; and
wherein the outer element cooperates in such a way with a circuit-breaker in the circuit that when the outer element is positioned in one of said inner positions the circuit-breaker closes the circuit, and when the outer element is positioned in said outer position the circuit-breaker breaks the circuit.

9. A thermometer according to claim 1, wherein the main element is substantially cylindrical in shape and outer element is oriented substantially axially and disposed substantially off-center relative to the main element.

10. A thermometer according to claim 1, further comprising:
an information device adapted to provide information about at least one of instantaneous temperatures measured by the thermometer and different foods with temperature information relating to each food.

11. A thermometer according to claim 10, wherein information about different foods with relating temperature information for each food can be shifted relative to a window in the main element so that the information becomes visible in the window.

12. A thermometer according to claim 10, wherein the information device is powered electrically by at least one battery disposed in the thermometer.

13. A thermometer comprising:
a main element;
an outer element mounted on the main element; and
a sensor mounted on the main element, the sensor having a projecting portion that extends from the main element and into the outer element;
wherein the outer element is movable relative to the main element between
a first position in which the outer element conceals the projecting portion of the sensor, and
a second position to expose the projecting portion of the sensor.

14. A thermometer according to claim 3, wherein said retaining device is a friction bushing.
